(19) United States
(12) Patent Application Publication
(10) Pub. No.: US 2012/0265634 A1
(43) Pub. Date: Oct. 18, 2012

(54) Buyer-Driven, Online Methods and Systems for Purchasing Motor Vehicles and Related Services

(76) Inventor: Michael Kinney, Katy, TX (US)

(21) Appl. No.: 13/413,374

(22) Filed: Mar. 6, 2012

Related U.S. Application Data
(60) Provisional application No. 61/451,107, filed on Mar. 9, 2011.

(51) Int. Cl. G06Q 30/06

(52) U.S. Cl. 705/26.4

(57) ABSTRACT

Buyer-driven methods of purchasing a motor vehicle include one or more buyers, each buyer composing a buyer-specific offer to purchase a motor vehicle and optionally motor vehicle-related services. Each offer is based on an individual buyer willing price that is based on an individual buyer perceived value of the motor vehicle and related services, and one or more buyer-specific conditions imposed on purchasing a motor vehicle within the set of motor vehicles. Buyers register with, and communicating their respective buyer-specific offer to, a website hosted by a computer server, the website accessible by network-connected devices of the buyers. One or more website-registered sellers communicate their respective seller conditions to the website, and software in a system server filters the buyer-specific offers. The sellers may accept, decline, or make alternative responses to the website, which ranks the seller response for buyers.

### BACKGROUND INFORMATION

Purchasing automobiles online has increased in popularity. Online automobile providers continue to offer more and unique services to buyers to enhance their buying experience. Providing ease of purchase and flexibility to buyers is an important goal.

The present online methods and systems for purchasing motor vehicles and related services do not enable the buyers to enter the terms (including the price they want to pay), send the terms to multiple dealers, and have the dealers respond electronically (and anonymously) to these terms. Current methods and systems provide seller-mandated terms and pricing.

In today's electronic and social media culture, buyers not only want to dictate the terms but also want sellers to provide expeditious responses to their proposals through the advent of electronic media. An additional benefit to the buyer is they avoid face-to-face contact with the salespeople.

### TECHNICAL FIELD

The present disclosure relates generally to purchasing automobiles, and more particularly, to a method and apparatus for buying automobiles under terms dictated by the buyers.

The present disclosure relates in general to methods of purchasing motor vehicles, for example, but not limited to, automobiles (cars), trucks, recreational vehicles, industrial vehicles, agricultural vehicles, and the like, and more particularly to buyer-driven, online (web-based) methods of purchasing motor vehicles and related services, such as, but not limited to, warranty and repair services.

### BACKGROUND ART

Not Applicable

Modern web-based and traditional walk-in motor vehicle buying and selling systems are all based on a seller controlled and seller published price system. Modern car buyers are highly informed and generally have performed research and are quite confident about the “conditions” whereby they are willing to buy a car. Car buyers are consistently trying to find an overall better “experience” and more “satisfaction” in car buying. Motor vehicle buyers, whether consumers or corporate purchasing department personnel, want to have more “control” over the overall process including the time they want to spend on searching for the right motor vehicle.

Systems such as eBay.com and Autotrader.com have provided new web-based systems to buy and sell automobiles. None of these systems have given buyers “control” of the buying transaction. These systems make the buyer spend a significant amount of time searching or bidding for cars based on “published” price by the seller.

Systems such as Priceline.com's “name your own price” (as described in U.S. Pat. Nos. 5,794,207; 7,472,074; and 7,386,508, as well as other patents) have been successful in giving the “Buyer” control of the transaction in the travel industry. The '207 patent discloses methods and apparatus wherein prospective buyers of goods and services communicate binding offers globally to potential sellers, for sellers to search for relevant buyer purchase offers, and for sellers potentially to bind a buyer to a contract based on the buyer's binding purchase offer. Both the '207 and '074 patents require buyers to upload payment identifiers (for example credit card information) before the buyer's conditional purchase orders are transmitted to potential sellers. The '508 patent discloses a method and apparatus for facilitating a transaction between a buyer and one seller. A seller server receives an offer that specifies a type of product (e.g. a seat on a flight), at least one condition (e.g. destination and date of departure), and an offer price specified by a buyer. The seller server also receives an associated payment identifier that specifies a financial account, such as a credit card account. The payment identifier essentially “guarantees” the offer in that the seller may receive payment from the financial account even if the buyer attempts to renege. The seller determines whether to accept the offer, based on various factors such as the offer price and the availability of appropriate products to satisfy the conditions of the offer. If the offer is accepted, payment is provided to the seller using the payment identifier. U.S. Pat. No. 7,516,089, also assigned to Priceline.com, has a stated goal of maximizing seller revenue in such buyer-driven electronic commerce systems. As with the previous patents, this patent also requires buyers to upload a payment identifier before the conditional offer is transmitted to sellers, as well as an authorization to charge the payment identifier.

U.S. Pat. No. 7,302,404 claims a method of facilitating a transaction using a computer connected to a network to match buyers and sellers, the method comprising having said computer search websites on said network for want ads from buyers, said want ads referring to a wanted good or wanted service; having said computer search websites on said network for sell ads from sellers, said sell ads referring to an advertised good or wanted service; having said computer match at least one want ad with at least one sell ad based on programmed rules; and notifying the associated buyer who posted said want ad that at least one sell ad has been matched to said want ad.

What are needed are unique methods and systems that put the “buyer in control” of the motor vehicle and related services buying process. What is further needed is change in the transaction of buying motor vehicles such as automobiles, trucks, SUVs, RVs and motorcycles, and related services to enable the buyer to enter what they are willing to pay (“willing price”) based on their conditions and their perceived value of a motor vehicle and/or services related to buying such a vehicle. The seller of the motor vehicle and/or related service can then accept, decline or suggest an alternative to the buyer's offer. What are further needed are methods and systems that may be considered “unconventional” and “game changers” in the motor vehicle buying and selling industry, in that prices are determined by the buyer—not posted by the seller. These systems and methods would be a successful way to achieve higher satisfaction in the buying experience for both the buyer and seller.

### SUMMARY

In accordance with the present disclosure, we have discovered methods, systems and computer-readable media (“CRM”) having executable code to carryout such methods and systems, for purchasing motor vehicles where buyers upload buyer-specific offers based on what they, as individuals or business entities, are willing to pay (“willing price”) based upon their requirements and their perceived value of a motor vehicle and related services. Sellers of motor vehicles and/or motor vehicle—related services can then accept, decline or suggest one or more alternatives to buyer-specific offers. These methods, systems, and CRM may be considered “unconventional” and “game changers” in the motor vehicle buying and selling industry, in that prices are determined by the buyer—not posted by the seller. In addition, these methods, systems, and CRM may be a successful way to achieve higher satisfaction in the car buying experience for both the buyer and seller.

In methods and systems in accordance with the present disclosure, the buyer (as used herein the singular includes the plural unless specifically called out otherwise) defines buyer-specific conditions (i.e., price, geography, make, model, year of manufacture, and the like) to compose a buyer-specific offer. This buyer-specific offer will stay valid until the buyer either withdraws the offer, closes accepting offers, completes a car buying transaction, or a buyer-driven time frame for the transaction expires. The system will filter buyer-specific offers in order to reduce or eliminate instances of “spam” offers (for example ridiculously low offers or other offers sellers are not interested in), and the system will notify sellers only after filtering out offers that sellers may not be interested in, depending on seller criteria input into the system. The seller will be allowed to accept buyer-specific offers with one or more vehicles, decline buyer-specific offers, decline buyer-specific offers by not participating in the process, or suggest one or more alternatives that will align with the “price/price range” of a buyer-specific offer. The buyer will be able to define a single price or a price range as the “willing price” to pay.

The binding of specific buyers and sellers will be kept “anonymous” until the “ready to buy the car” state of buying process is achieved, which state is solely determined by buyers. The buyer will commit to a sale by indicating so to a seller via a computer server hosting a website and a communications network connecting the buyers and sellers, and will also finalize the transaction using these features. Once the transaction is finalized, the hosted website will bind the buyer and seller where the final motor vehicle and/or service-buying transaction will be executed between the buyer and seller directly.

A first aspect of the disclosure is a buyer-driven method of purchasing a motor vehicle, the method comprising:

one or more buyers composing a buyer-specific offer to purchase a motor vehicle and optionally motor vehicle-related services, each offer based on an individual buyer willing price that is based on
i) an individual buyer perceived value of the motor vehicle and related services, and
ii) one or more buyer-specific conditions imposed on purchasing a motor vehicle within the set of motor vehicles;

each buyer registering with, and communicating their respective buyer-specific offer to, a website hosted by a computer server, the website accessible by network-connected devices of the buyers via an information network comprising said server, and one or more website-registered sellers communicating their respective seller conditions to the website via the information network prior to any buyer financial information being communicated to the website by the buyers;

filtering, using software in or accessible to the computer server, one or more buyer-specific offers with respect to one or more registered seller conditions, the computer server electronically communicating only filtered buyer-specific offers to registered sellers;

the registered sellers communicating a response selected from the group consisting of accept, decline, or alternative response to the website;

if satisfied with one or more registered sellers' acceptance or alternative responses, each buyer selecting one registered seller the buyer wishes to purchase the motor vehicle from and anonymously communicating a “ready to purchase motor vehicle” signal and financial deposit information to the website for the selected registered seller, the website subsequently identifying the selected registered seller to the respective buyer and identifying the respective buyer to the selected registered seller;

the computer server then causing the website to indicate “pending sale” for the buyer and the selected registered seller;

only if the respective buyer remains committed to purchasing the vehicle from the selected registered seller and only if the registered seller commits to selling the vehicle to the buyer, then the selected registered seller and the respective buyer executing a purchase and sale contract using the website.

In certain embodiments, if either the buyer or the seller decides to back out of the sale after the “pending sale” signal is posted on the website, the system initiates an issue resolution procedure. In certain embodiments the issue resolution procedure may comprise the system asking the buyer and seller to first discuss their differences for a specific period of time, perhaps 10 days. In certain embodiments, after the discussion period is concluded and if no resolution is made, the system initiates a dispute resolution procedure, such as mediation or arbitration, to determine which party is at fault for backing out of the “pending sale” and to penalize the party at fault. The penalty may be, for example, forfeit of a deposit, and/or other remedies. In certain embodiments, the buyer-specific offer will revert back to its state before “sale pending” status, and the buyer may select another registered seller with which to do business with. In certain method embodiments, the seller feedback is communicated anonymously. Certain embodiments comprise the computer server anonymously ranking the seller feedback for each matched buyer-specific offer. In certain other embodiments, the methods further comprise the selected sellers and the respective buyers each informing the website of the execution of their respective purchase and sale contracts In certain embodiments, the method further comprises the computer server retaining buyer deposits for those transactions not executed by buyers with selected sellers.

In certain method embodiments, buyers compare their willing price to industry knowledge and adjust their willing price to form a buyer-specific adjusted willing price. In still other methods, buyers communicate their buyer-specific adjusted willing price to sellers via the information network.

“Motor vehicle” as used herein may include, but is not necessarily limited to, automobiles, light-duty trucks such as pickup trucks, all terrain vehicles (ATV), motorcycles, and industrial vehicles such as dump trucks, tractor trailers, ore haulers, road graders, and the like. The term “automobiles” includes, but is not necessarily limited to, mini cars, sub-compact cars, compact cars, midsize cars, full size cars, luxury cars, sports cars, sports utility vehicles (SUV), recreational vehicles (RV) and multipurpose vehicles (MPV), and the like.

“Industry knowledge” includes, but is not necessarily limited to, Kelly Blue Book value, National Automobile Dealers Association (NADA) guide value, CARFAX vehicle history reports and other information, and combinations thereof. In certain embodiments the industry knowledge is available online via the information network, which may be the Internet, semi-private or private Intranet, a telephonic network, and the like. In certain embodiments the industry information may be available locally in the buyer's geographic area, regionally (for example, the New England states of the US), or globally.

In certain embodiments the computer server may generate suggestions to buyers about adjusting the buyer conditions and/or the willing price. In these embodiments, the computer server may either generate the suggestions and allow buyer buyers to access them, or simply allow buyers to access suggestions posted by one or more sellers, or both. For example, the computer server may generate and allow buyer access to lists based on volume of seller acceptances, or may simply allow buyer access to alternate solutions proposed by one or more sellers, and decline comments posted by one or more sellers.

In certain methods, one or more of the potential sellers may provide one or more motor vehicle-related services including, but limited to, vehicle inspections, CARFAX reports, financial loans, vehicle insurance, dealer special offers and advertisements, vehicle maintenance services, extended warranties, and vehicle shipping/transportation.

In methods wherein one of the potential sellers accepts one of the buyer-specific offers and the buyer and seller consummate a binding purchase and sale contract for a motor vehicle, the buyer may communicate a desire to view motor vehicle-related services related to the motor vehicle purchase that may be provided from one or more sellers. In certain methods the purchase and sale contract is consummated through an online payment service, such as the service known under the trade designation PayPal. In certain methods, the buyer purchases the vehicle using a credit card.

In still other methods, if one or more of the sellers is not willing to sell to one or more of the buyers based on the buyer-specific offers, the one or more sellers may communicate one or more actions selected from the group consisting of declining one or more of the buyer-specific offers and suggesting one or more alternatives to one or more buyer-specific offers.

Certain methods may comprise one or more sellers registering with the computer server and/or website and/or sponsor thereof and creating a seller profile identifying seller conditions and contact information for the seller, including one or more electronic mail addresses. In certain methods, the computer server may forward by electronic mail (with or without additional packaging) one or more buyer-specific offers to one or more potential sellers that match seller conditions. In some embodiments, the computer server may forward the offers to multiple electronic mail addresses of a seller, as identified in the seller's profile posted to the website.

In certain methods, one or more sellers may provide specific details of a particular motor vehicle and/or motor vehicle-related service that would be transacted by accepting the buyer-specific offer. In certain methods, one or more sellers may upload one or more images, videos or other descriptive material of the motor vehicle or motor vehicle-related service to be purchased to the computer server.

Certain methods may comprise the computer server ranking sellers in a list of accepted buyer-specific offers and counteroffers ranked in order of the closest match to buyer-specific offers.

In certain methods in accordance with the present disclosure, buyer identities are not revealed to sellers, and seller identities are not revealed to buyers until a buyer transmits a “ready to purchase” signal to the website.

A second aspect of this disclosure are systems comprising:

an information network comprising a computer server hosting a website accessible by network-connected devices of potential buyers and potential sellers of motor vehicles and related services, the computer server comprising features allowing buyers and sellers to register with the website, and allow buyers to upload buyer-specific purchase offers for motor vehicles and sellers to upload registered seller acceptances, alternate seller solutions and seller decline comments, without any obligation of buyers to consummate a purchase and sale contract,

the computer server further comprising, or having ability to electronically access remotely, software that allows the computer server to:
i) filter registered buyer-specific offers,
ii) communicate filtered buyer-specific offers to registered sellers using the information network,
iii) receive messages from buyers satisfied with one or more registered sellers' acceptance or alternative responses, the messages allowing the buyer to select a seller the buyer wishes to purchase the motor vehicle from and anonymously communicate a “ready to purchase motor vehicle” message and financial deposit information to the website, prior to the website identifying the selected seller to the respective buyer and the respective buyer to the selected seller;
iv) identify buyer-selected sellers and respective buyers using the information network,
v) execute respective purchase and sale contracts using the website, but only after the buyers and sellers identify themselves to each other using the website,
vi) retain the buyer deposit for those instances where the buyer backs out of a “ready to purchase” status, but only if the buyer was at fault.

Certain systems of this disclosure include those wherein the computer server comprises, or has ability to electronically access remotely one or more buyer-driven algorithms allowing buyers to access information available online in forming the buyer-specific purchase offers. In certain systems the computer server software is programmed to allow one or more buyers to rank seller acceptances and seller alternate solutions. In certain other systems, wherein the purchase order includes a willing price and buyer-specific conditions, the server may comprise software programmed to generate suggestions to buyers about adjusting the buyer conditions and/or the willing price. In certain systems, the server software generates the suggestions based on information selected from the group consisting of volume of seller acceptances, alternate seller solutions and seller decline comments.

Another aspect of the disclosure is a method of facilitating and capitalizing a buyer-driven method of purchasing a motor vehicle, the method of facilitating and capitalizing comprising:

setting up a website wherein a set of buyers and a set of sellers of motor vehicles register with the website via an information network, the information network comprising a computer server hosting the website accessible by network-connected devices of the buyers and sellers;

each individual buyer composing a buyer-specific offer to purchase a motor vehicle and optionally services, each offer based on an individual buyer willing price that is based on
i) an individual buyer perceived value of the motor vehicle and related services, and
ii) one or more buyer-specific conditions imposed on purchasing the motor vehicle;

one or more sellers composing one or more seller conditions on selling the motor vehicle;

the website facilitating buyers to communicate their respective buyer-specific offers to the website and sellers to communicate their respective seller conditions to the website via the information network prior to any buyer financial information being communicated to the website by the buyers;

filtering, using software in or accessible to the computer server, one or more buyer-specific offers with respect to one or more registered sellers and electronically communicating only filtered buyer-specific offers to registered sellers;

one or more sellers communicating to the website anonymous seller feedback selected from the group consisting of accepting, rejecting, and proposing one or more alternatives to one or more filtered buyer-specific offers;

the computer server anonymously associating the anonymous seller feedback with filtered buyer-specific offers and anonymously ranking on the website the seller feedback for each filtered buyer-specific offer;

one or more buyers evaluating the anonymous seller feedback and ranking, and, if satisfied with one or more sellers, each buyer selecting seller the buyer wishes to purchase the motor vehicle from and anonymously communicating a “ready to purchase motor vehicle” signal and financial deposit information to the website;

the website identifying the selected registered seller to the respective buyer and identifying the respective buyer to the selected registered seller, the selected registered seller and respective buyer;

the computer server then causing the website to indicate “pending sale” for the buyer and the selected registered seller;

only if the respective buyer remains committed to purchasing the vehicle from the selected registered seller and only if the registered seller commits to selling the vehicle to the buyer, then the selected registered seller and the respective buyer executing a purchase and sale contract using the website, the selected seller and the respective buyer each informing the website of the execution of their purchase and sale contract; and

the computer server retaining the buyer deposit only for contracts that were not executed due to fault of the buyer.

In certain methods, after evaluating the anonymous feedback and ranking, but prior to communicating the “ready to purchase motor vehicle” signal and financial information to the website, a buyer may send to the website one or more electronic messages addressed to one or more sellers, the website then sending website-generated electronic messages to the one or more addressed sellers. The one or more electronic messages may include the buyer requesting the seller inform the buyer of one or more motor vehicle-related services that the seller may provided, and optionally one or more price quotes for those services.

Another aspect of the disclosure are computer-readable media encoded with processing instructions for implementing any of the buyer-driven methods of purchasing a motor vehicle as detailed herein.

Yet another aspect of the disclosure are computer-readable media encoded with processing instructions for implementing any of the methods of facilitating and capitalizing any of the buyer-driven methods of purchasing a motor vehicle as detailed herein.

The methods, systems, and computer-readable media described herein may provide many benefits to buyers and sellers of motor vehicles, the first being that both buyer and seller must agree to the transaction in the context of the system. The methods and systems described herein differ from usual motor vehicle pricing systems, and particularly those used in automobile pricing. In methods and systems described herein, buyers offer what they are willing to pay based on their specific, perceived value of the product or service. One or more sellers can then accept or decline the buyer's offer. These methods and systems may be considered unconventional in that prices are determined by buyers—not posted by sellers.

Another benefit of methods and systems of the present disclosure is that they allow sellers to be selective in their transactions with customers, and thus manage their profits. If a price proposed by a buyer does not meet the profit margin desired by the seller, then the seller can decline the offer, or suggest an alternate and wait for a better deal. This level of control is not possible if prices are determined by sellers who must guess as to how much buyers are willing to spend for particular automobiles.

Yet another advantage of methods and systems of the present disclosure is that the transactions are individualized. The described methods and systems allow buyers, as individuals, to act based on their own personal finances. The value of any given product or service is inherently subjective, and thus removing objective pricing allows individuals to contemplate its worth on a purely individualized level. Buyers, as individuals, have the opportunity to be more honest with themselves as to motor vehicles they can afford.

Still another advantage of methods and systems of the present disclosure is that both parties must agree. Methods and systems of the present disclosure are designed to leave both parties satisfied. Neither the buyer nor the seller is required to accept an offer that he/she is not comfortable accepting. The buyer-driven, buyer-specific offer methods and systems described herein are designed to take the “hustle” and “pressure tactics” of sellers related to car buying, and spamming of spurious offers made by less than honest buyers, totally out of the equation.

Yet another advantage of methods and systems of the present disclosure is that they are designed so that each transaction is a “specialized transaction” between a buyer and a seller. The transaction is not based on a published price by the seller. These methods and systems allow sellers to provide automobiles and services that cannot be subjected to competitive prices from other competitors of the seller since it is considered a one time, specialized transaction between a specific buyer and a specific seller.

These and other features of the methods and systems of the disclosure will become more apparent upon review of the brief description of the drawings, the detailed description, and the claims that follow.

### BRIEF DESCRIPTION OF THE DRAWINGS

The manner in which the objectives of this disclosure and other desirable characteristics can be obtained is explained in the following description and attached drawings in which:

FIG. 1 illustrates schematically, in Unified Modeling Language (UML) sequence diagram form, a prior art seller-driven concept for motor vehicle sales and purchasing;

FIG. 2 illustrates schematically, in UML sequence diagram form, a first method and system of this disclosure for buyer-driven, online purchase and sale of motor vehicles;

FIG. 3 illustrates schematically, in UML sequence diagram form, a second method and system of this disclosure for facilitating and capitalizing the buyer-driven, online method and system of FIG. 2;

FIG. 4 is a schematic UML activity diagram illustrating the method embodiments of FIGS. 2 and 3; and

FIGS. 5A-C are schematic UML deployment diagrams illustrating the method embodiments of FIGS. 2 and 3.

It is to be noted, however, that the appended drawings are not to scale and illustrate only typical embodiments of this disclosure, and are therefore not to be considered limiting of its scope, for the methods and systems of this disclosure may admit to other equally effective embodiments. Identical reference numerals are used throughout the several views for like or similar elements.

### DETAILED DESCRIPTION

In the following description, numerous details are set forth to provide an understanding of the disclosed methods and systems. However, it will be understood by those skilled in the art that the methods and systems may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romantic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

As noted above, it has now been determined that buyer-driven, online purchasing of vehicles, as opposed to auctions or reverse-auctions, may be more efficient use of time and may lead to a more enjoyable purchasing experience for both buyers and sellers. Methods and systems of this disclosure are applicable to vehicles such as, but not limited to, transportation vehicles such as automobiles (sometimes referred to herein as “cars”) trucks, and buses of all sizes without limit to size or mode of operation (fossil fuel, electric plug-in, battery, solar, wind-driven, and hybrids); recreational vehicles, such as motor-homes, fifth-wheels, four-wheelers, three wheelers, and the like; industrial vehicles, for example, but not limited to wheeled, motorized construction equipment such as cranes, industrial material handling vehicles, such as ore haulers, earth movers, and the like, lift trucks and the like; and agricultural vehicles such as tractors, bailers, and the like.

As fully explained herein below with reference to the drawing figures, in accordance with the present disclosure, methods and systems for processing buyer-driven transactions to buy a vehicle, such as an automobile, and, optionally, services related to buying a vehicle, are presented. The buyer will submit an offer with a “willing price” to buy a vehicle and, optionally in some embodiments a service related to buying a vehicle. Methods and systems of facilitating and capitalizing buyer-driven purchasing of a vehicle are also presented.

In one exemplary embodiment of this disclosure, a centralized server, referred to generically herein as the “mycaratmyprice” server, or “MCAMP” server, or system server, is utilized to store the various information provided by buyers and sellers, and allow access to that information by those buyers and sellers to facilitate and complete one or more purchase transactions. A potential buyer may set up an account or the like on the mycaratmyprice server with a valid e-mail. The buyer will have the ability to create a profile to provide additional data (including a nominal deposit) to the seller to show the “seriousness” of doing business. The profile may contain information such as method of payment, pre-approved loan, time line for transaction, and the like.

Similarly, a seller wishing to use the features of the methods and systems of this disclosure to provide replies to buyer offers may set up an account through a seller registration user interface. The seller registration interface will be provided to allow a potential seller to provide and store various sale related information. The seller registration will allow the system to send only filtered buyer-specific offers to registered sellers, typically using e-mail, although other communication means may be employed just as well, such as telephone, video conference, and the like.

After setting up buyer and seller information on the mycaratmyprice system server, a potential buyer may use the system in order to present buyer-specific, conditional offers to by a vehicle and, if desired by the buyer, one or more optional related services. The system server will then filter buyer offers, and only filtered buyer-specific offers will be communicated to sellers, typically through electronic mail (sometimes referred to herein as “e-mail”), regular mail, or other means. In certain embodiments, the system server will allow sellers to log into their account and view all matching buyer offers. In certain embodiments, the system server will allow sellers to log various responses, such as “accept”, “reject with comments”, “reject without participation” or “provide alternates” that match the “willing price” of one or more buyer offers, and sellers will also be able to view all offer(s) accepted, rejected or an alternate provided. In certain embodiments, the system server will allow sellers to upload pictures, videos and descriptions of the car or services to one or more buyers. In certain embodiments, the system server will monitor all content to ensure the anonymity of the buyer and the seller is maintained until the transaction is finalized. In certain embodiments, the system server will allow buyers to log into the system and view some or all seller feedback to each buyer offer. In certain embodiments, the system server will facilitate anonymous communication between buyer and seller to discuss the offers and feedback.

In certain embodiments, the system server will monitor all buyer offers, seller feedback and all communication between buyers and sellers to make sure all content on the server follows rules and regulations set forth by the sponsor of the system and agreed upon by sellers and buyers at registration. In certain embodiments the system server will rank all seller feedback for each buyer offer to provide the buyer the top X seller feedback for the offer. A buyer will be allowed to mark one offer as “ready to buy the vehicle” and pay a buyer deposit to the system sponsor to tentatively bind the buyer into a “prospective buying agreement”. The offer will be a “pending sale” or “sale pending” status at this time, and the system will so indicate on the website. The buyer or seller may back off of this state, but there may be a need for “issue resolution” mediation by the system to decide who is at fault for backing off of the “pending sale” state, and the system may penalize the party at fault of their deposit, or invoke some other or additional remedy, such as restrict a party from accessing the website for a certain time period. The buyer offer then will revert back out of “pending sale” and the buyer may select another seller they want to go into a “pending sale” state. Once the buyer and a seller have agreed to proceed to a purchase and sale contract, the system server will reveal the identity of buyer to seller, and seller to buyer. The buyer must execute a purchase transaction if all information provided by the seller is accurate. In certain embodiments, the seller will be charged a fine from the system sponsor if the transaction fails due to seller negligence. In certain embodiments, the buyer will forfeit the buyer deposit if the transaction is not consummated. If the transaction is consummated then the buyer deposit will be applied towards the purchase transaction. Confirmation from buyer and seller that a transaction has been completed is sent to the system server. For example, if a particular seller uses the system and methods of the invention often or more than an agreed on minimum per month or other time period, an adjustment may be made to lower the seller's commission. In extreme cases, according to rules set out at registration, particular buyers and sellers may be barred from using the methods and systems described herein. The duration of the bar may be determined on a case by case basis, or other basis. The system may also provide a form of buyer protection agreement, such as known in the art. The e-commerce business model of eBay, Inc., provides such a buyer protection agreement in limited circumstances.

In certain embodiments, systems and methods of the present disclosure may require buyers to evaluate and rate their transaction at the end of a successful transaction or at the time a buyer's offer is removed from the system. In certain embodiments, seller ratings may be shown every time a buyer offer is published using the system. In most embodiments, identity information of seller and buyer is withheld until the transaction is finalized.

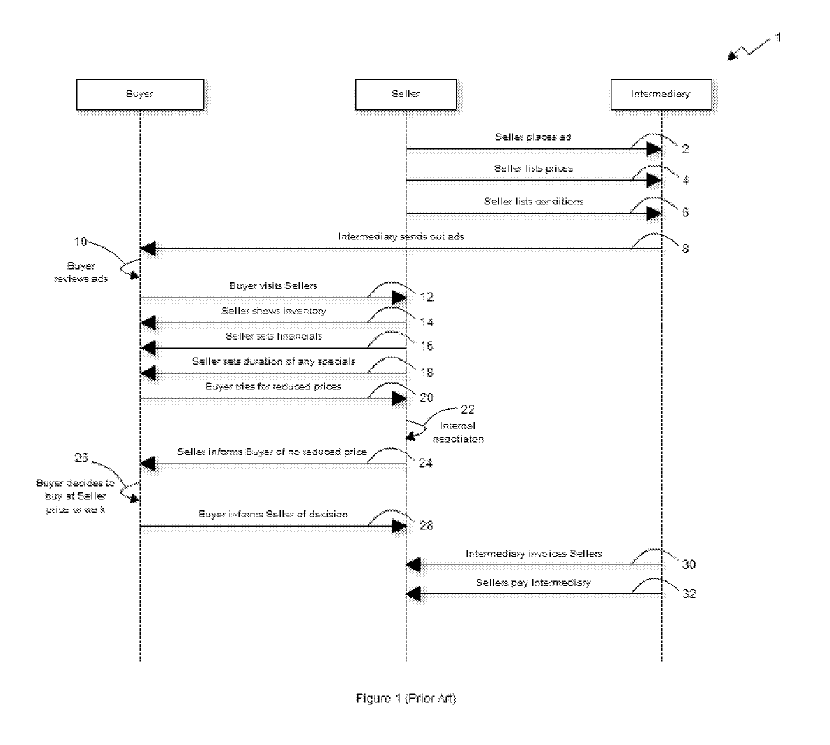

Referring now to the drawing figures, FIG. 1 illustrates schematically, in Unified Modeling Language (UML) sequence diagram form, a prior art seller-driven embodiment, 1, for motor vehicle sales and purchasing transactions between Buyers, Sellers supported by Intermediaries, such as a newspaper, radio station, television station, or the Internet. In a typical prior art vehicle purchase and sale, sellers place advertisements 2 with list prices 4 and usually some seller conditions, 6, such as “this weekend only”, or sales prices only good on current year models. The intermediary sends out or publishes the advertisements, 8. Buyers review the advertisements, 10, and then typically visit one or more retail dealers, 12. During these visits, a sales associate would typically show inventory, 14, and the sales associate or another individual explains any financial deals available to buyers, 16, and explains or sets duration of any special deals available to qualified buyers, 18. During a typical visit, a buyer may try negotiating for a reduced price on one or more vehicles with a sales associate, 20. If negotiations reach a serious point, the sales associate may seek counseling from a sales manager or owner of the dealer, 22. In many cases, the sales associate informs the buyer that no price reductions are being considered at this time, 24. At this point, the buyer has a decision 26 to make: either buy at a price uncomfortable for the buyer and set by the seller, or walk away from the negotiation. In either case, the buyer informs seller of buyer's decision, 28, and buyer may be left feeling “taken advantage of”, or otherwise unsatisfied. In either case, the intermediary invoices seller 30, and seller pays the intermediary, 32.

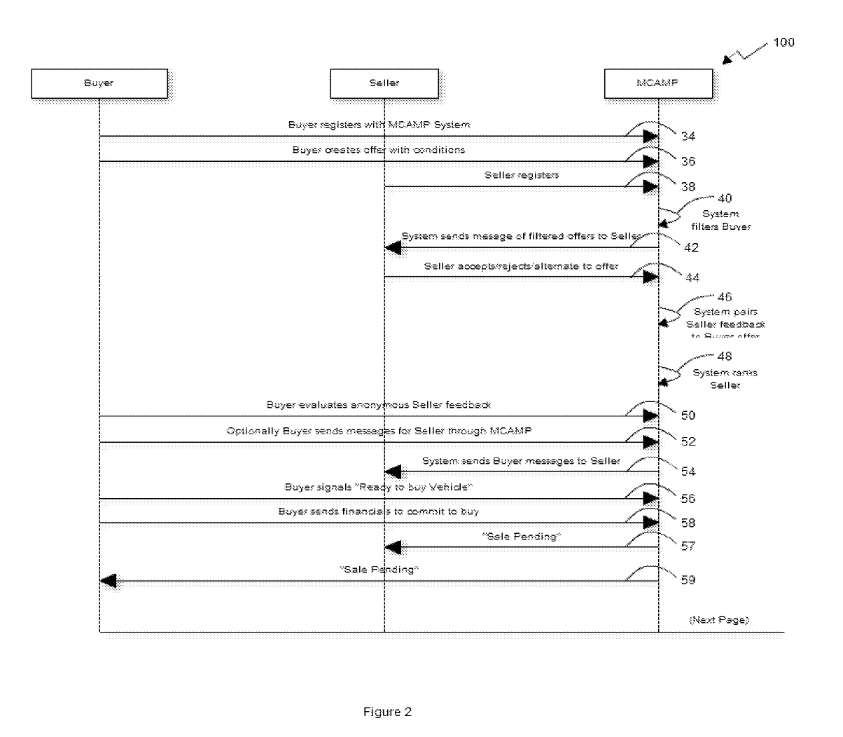

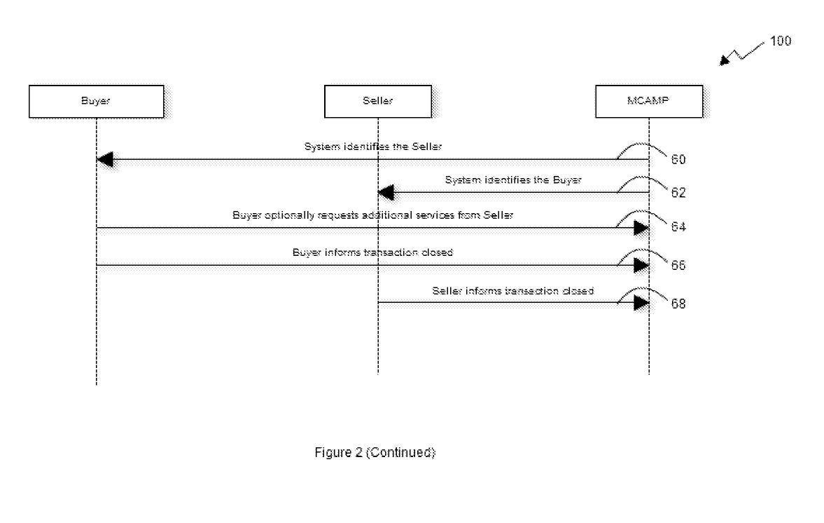

FIG. 2 illustrates schematically, in UML sequence diagram form, a first method and system embodiment 100 of this disclosure for buyer-driven, online purchase and sale of motor vehicles. In embodiment 100, the intermediary is referred to as MCAMP (an acronym for “mycaratmyprice”), or simply as the system server. Buyers register with the system, 34, and create offers with buyer-specific conditions which the buyers e-mail or otherwise communicate to the system so they may be posted on a website hosted by the system server, 36. One or more sellers also register with the system and forward their seller conditions to the system so that they may be posted for access by buyers on the website, 38. In methods and systems in accordance with the present disclosure, the system server filters buyer-specific offers and conditions, and only those buyer-specific offers that pass the filter are communicated to sellers of certain motor vehicles, 40. The system server sends messages, e-mails in certain embodiments, to sellers, 42.

At this point, in contrast to embodiment 1 of FIG. 1, sellers have a decision to make, whether to accept a buyer offer, reject a buyer offer, or propose an alternative deal to a particular buyer, 44. In certain embodiments, such as in embodiment 100, the system server pairs seller feedback to buyer offers, 46, and in certain embodiments, such as embodiment 100, the system server ranks seller feedback so that buyers may compare responses of various sellers, 48. Buyers may then evaluate anonymous seller feedback, 50, and in certain embodiments may send e-mail messages 52 to the system server, asking the server to in turn send messages 54 to sellers asking for further information or clarifying seller information and/or conditions. The system server may send the messages “as is” or may re-package the messages, in accordance with messaging rules set up in advance by the sponsor of the system and method.

At this point, buyer may be ready to commit to purchase a motor vehicle from a seller, but wishes more time to think about the different seller deals, or may just wish to (or is required to) delay a decision for some reason, a for example to discuss with other family members, or seek approval from business associates. To do this, buyers may use methods and systems of the present disclosure to lock in one or more deals by sending a “ready to buy the vehicle” signal to the system server, 56, along with a corresponding buyer financial commitment for a buyer deposit, 58 associated with the “ready to buy” signal. Once this has been registered with the system server, the purchase is not closed at this time. The offer will go into “pending sale” or “sale pending” (these terms are used interchangeably herein) state at this time, and the system so indicates, as noted at 57 and 59. The buyer or seller may back out of this state, although as previously explained this might require “issue resolution” mediation by the system to decide who is at fault for backing out of the “pending sale” state, and in certain embodiments will penalize the party at fault by requiring that party to forfeit their deposit. The buyer offer then will revert back out of “pending sale” status, and the buyer may then select another seller to go into a “pending sale” state. Only after a buyer and a seller have agreed on all issues, the system server identifies the seller to the buyer 60, and identifies the buyer to the seller 62, typically by e-mail, although this is not necessary, as other means may be used such as telephone or text messages. Buyers may then, optionally, request sellers to provide other services, such as CARFAX information on the vehicle, and/or provide quotes on other services, such as financing or post-sale warranty or non-warrantee maintenance services.

The buyer then informs the system server that the transaction has closed, 66, and seller as well informs the system server of the same information, 68. If the buyer does not close or execute the transaction, buyer forfeits the deposit to the sponsor of the system. For those transactions that do close, the buyer deposit is applied toward the purchase price of the motor vehicle.

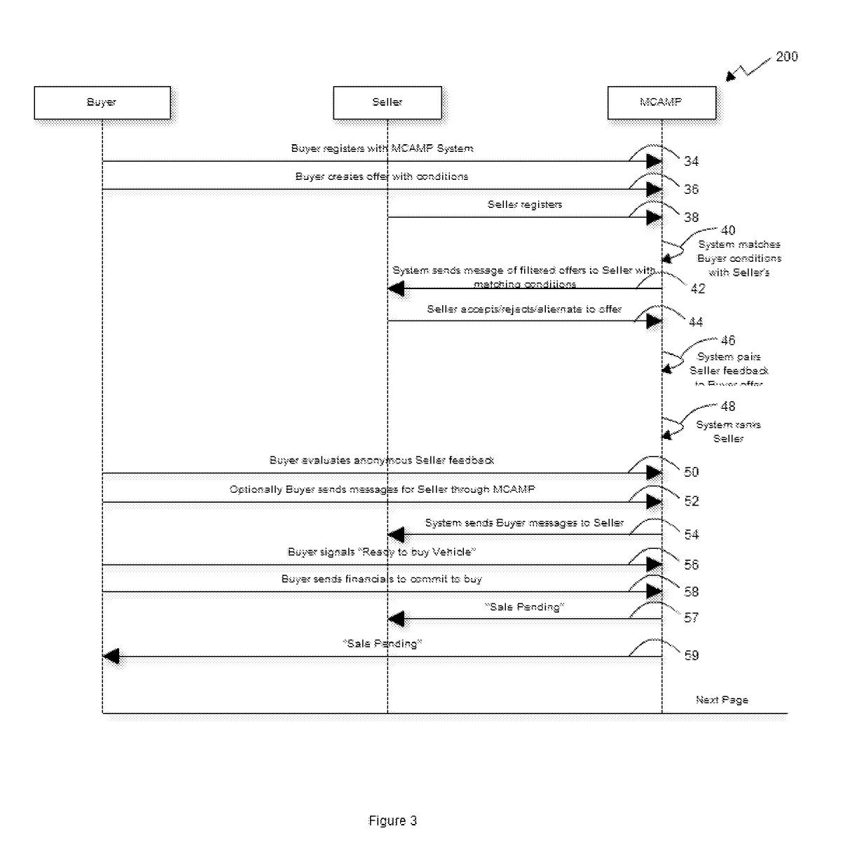

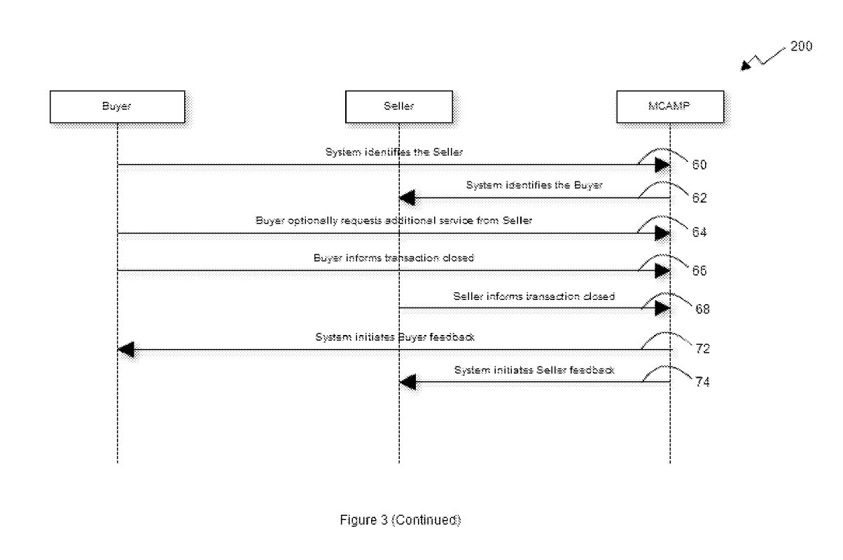

FIG. 3 illustrates schematically, in UML sequence diagram form, a second method and system embodiment 200 of this disclosure for facilitating and capitalizing the buyer-driven, online method and system of FIG. 2. The steps are the same as in embodiment 200, except that in embodiment 200, the system server-requests buyer and seller feedback, 72, 74 on any complaints they may have regarding the system or a particular buyer or seller, or how to improve the method and system.

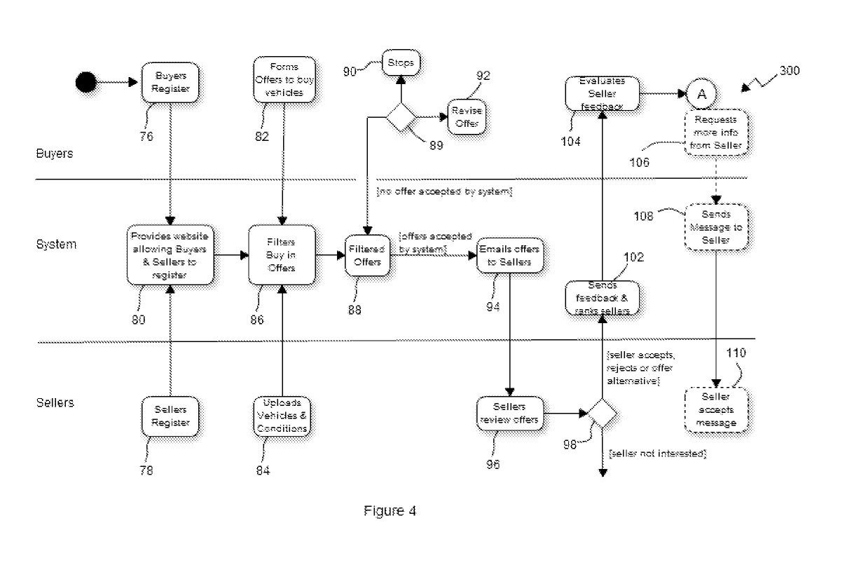

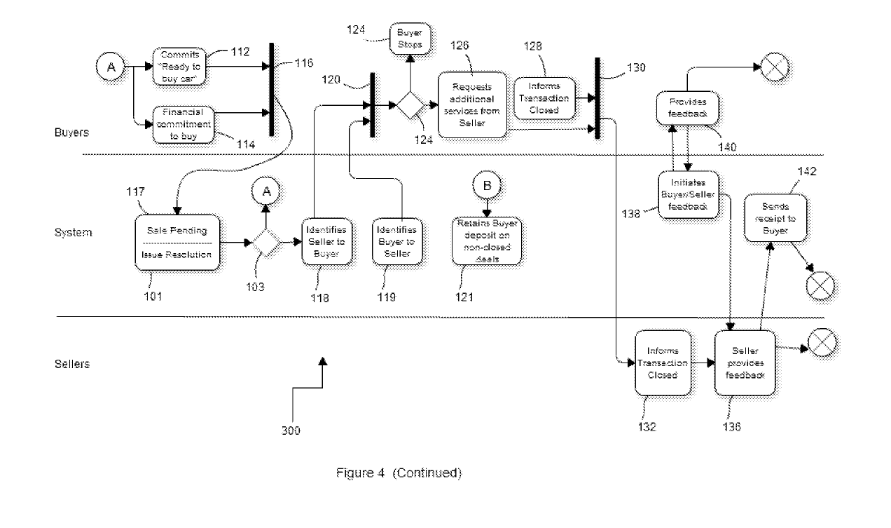

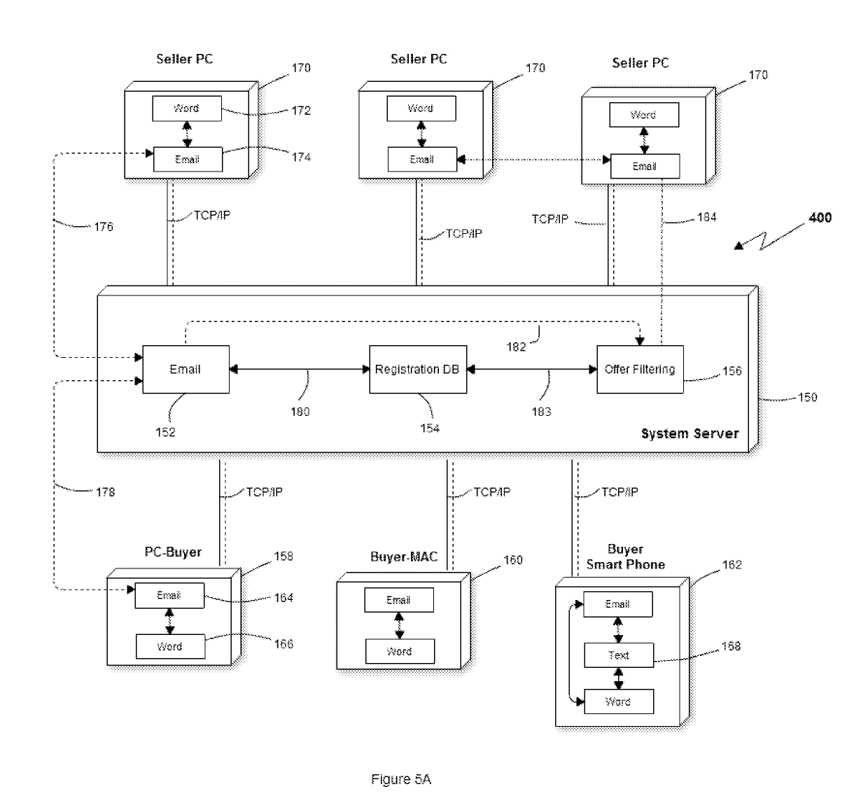

FIG. 4 is a schematic UML activity diagram illustrating the method and system embodiments of FIGS. 2 and 3, as well as some other features, and is therefore labeled embodiment 300. In embodiment 300 of FIG. 4, the activities of the actors are arranged in lanes, one lane labeled “Buyers”, one lane labeled “System”, and the last lane labeled “Sellers.” This is not to imply that there may not be other lanes, for example for regulatory agencies and the like. As with previous embodiments 200 and 300, buyers register with the system, 76, as do sellers, 78. The system provides a website allowing buyers and seller to register, 80. Buyers form buyer-specific offers to purchase motor vehicles, 82, based on their own specific circumstances. Sellers upload available motor vehicles for sale and seller conditions for each motor vehicle, 84. The system server filters buyer-specific offers at 86, and only those that pass through the filter are made available to sellers, 88, 94. Sellers review the filter-accepted offers, 96. If a buyer-specific offer is not accepted by the system, that buyer has a decision to make, 89, either stop the effort, 90, or revise the offer and try another posting, 92. If a buyer-specific offer is accepted by one or more sellers, the buyer will select one seller to move to the “ready to purchase” state by depositing a fee, 112, 114. The offer is not closed at this time. The offer will go into “pending sale” state at this time, 117. The buyer or seller may back out of this state, and the system performs, in this embodiment, “issue resolution”, 101, to decide who is at fault for backing out of the “pending sale” state, and penalizes the party at fault of their deposit. The buyer offer then will revert back out of “pending sale” and buyer may select another seller they want to go into a “pending sale” state. The system server transmits messages (e-mail, telephone calls, or text messages, for example) to the seller, and seller decides at 98 either “not interested”, or to respond to the system server with an acceptance, a rejection with comments, or an alternate counteroffer. During the “pending sale” period, the system server may send feedback from seller to buyer, and may in certain embodiments rank seller responses, 102. Buyer then evaluates seller feedback, 104. Optionally, buyer may request more information from the selected seller, 106, by e-mailing or otherwise messaging the system server, and the system server then may send the messages directly to the selected seller, or re-package the message, and then transmit it to the selected seller, 108, which are received by selected seller, 110.

Join symbol 116 indicates that both 112 and 114 must occur before the system will indicate “sale pending” status 117 and perform any issue resolution, 101. If all issues are resolved between buyer and seller, the system at 103 decides to identify the selected seller to the buyer, 118, and identify buyer to the selected seller, 119, and join symbol 120 indicates that both identities must be known, in this embodiment, before a buyer may make a decision, 122. If the system decides there are issues that cannot be dissolved, or buyer or seller wishes to back out, the system removes the “sale pending” status, and buyer may revert to status “A”. Once buyer and seller are identified to each other, buyer may either stop the process, 124, and forfeits the deposit for that transaction if the system determines that the party at fault is buyer, which the system retains, 121, or buyer requests information on additional services from the seller in order to close the transaction, 126, 128. In embodiment 300, join 130 indicates that both 126 and 128 must occur before sellers are required to inform the system server that the transaction has closed, 132. The system server then invites buyer and seller to provide feedback to the system server, 138. Seller then provides any feedback deemed appropriate, 136. Buyer as well provides any feedback deemed appropriate, 140. Finally, in this embodiment, the system server sends a receipt to the buyer, 142.

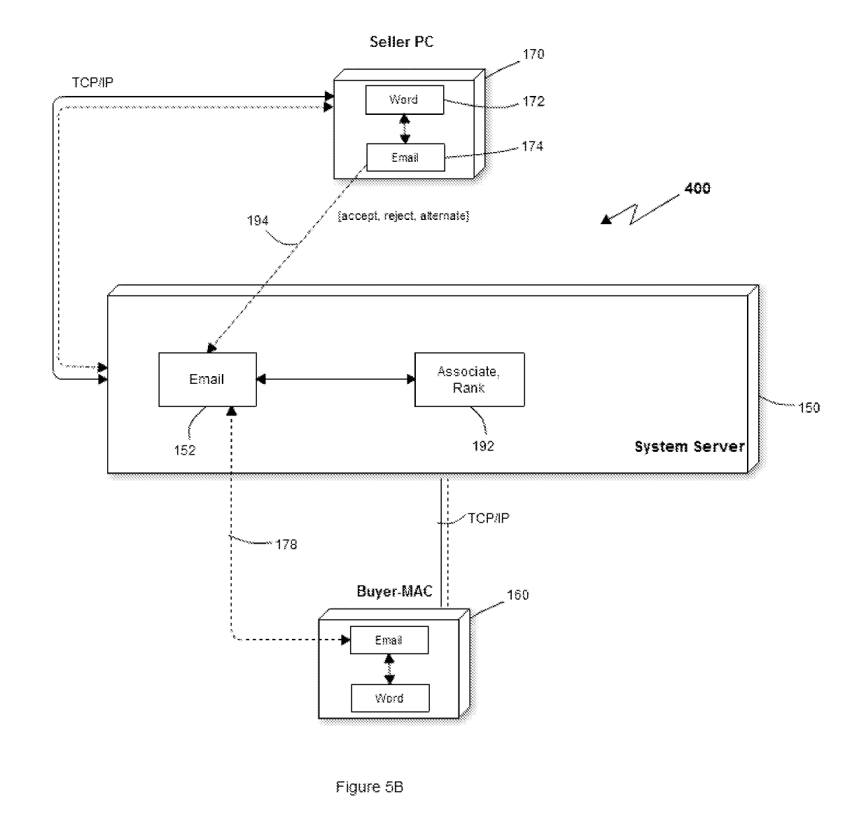

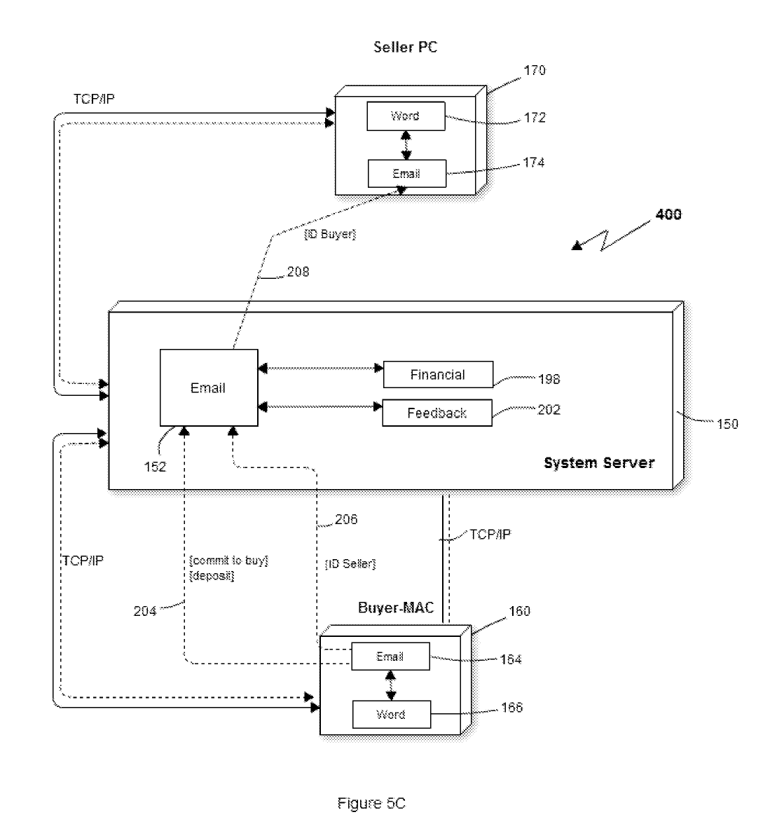

FIGS. 5A, B and C are schematic UML deployment diagrams illustrating aspects of one system embodiment 400 that may be used in carrying out method embodiments 100, 200, and 300 of FIGS. 2, 3 and 4. FIG. 5A illustrates a system server 150 as well as software components for e-mail (152), registration database (154), and offer filtering (156). Buyer devices capable communicating with system server 150 via a communications network (indicated as TCP/IP) are illustrated as possibly being a personal computer 158 running operating software known under the trade designation Windows® software (referred to herein as simply a “PC”), a buyer computer 160 using a computer known under the trade designation iMac, MacBook, or other computer running the Apple operating system known under the trade designation OS, or a buyer smart phone 162 running on any number of operating platforms currently available, such as an iPhone, Android phone, and the like. In operation, it will be understood that system server 150 may be connected with thousands or even millions of buyer network-connected devices all at once. Each buyer network-connectable device 158, 160, 162 at least includes software components for e-mail 164, word processing 166, and may include other software component or elements. The e-mail component 164 and word processor 166 are able to interact in known fashion, as is a text messaging software component 168 typically available in today's mobile phones. The server system is part of a telecommunication network including the TCP/IP connections, which are indicated both in solid lines as well as dashed lines, to indicate that the network may be a wired, wireless, or combination of wired and wireless networks. It should also be noted that the telecommunication system may include the Internet (or portion thereof) or a company Intranet, as one further example.

Seller network-connected devices are all indicated as PCs 170 (three are indicated, but it will be understood that system server 150 may be connected to tens, hundreds or more sellers). It should also be understood that one seller, for example one automobile dealer, may have one or more network-connected devices 170. Seller network-connected devices 170 will also normally include word processing software components 172, e-mail software components, 174, as well as other software. It will be understood that these representations are merely examples, and other methods of connecting via network-connected devices may be employed. For example, individual sales associates may employ text messaging devices, pagers, or other such devices that may be network-connected to system server 150, or to components 170 at a dealer location, which is then network-connected to the system server 150. Such variations are considered within the scope of methods and systems of the present disclosure.

Sellers register with system server 150 as indicated by communications link 176, and buyers may do the same via communications link 178, linking to software component 152 in system server 150. These may be e-mail or text message communications, although regular mail may be used for registering with system server 150, or its sponsor entity. E-mail software component 152 interacts electronically with registration database 154 through a link 180, and may link electronically also with offer matching software component 156 through another electronic link 182, although the latter will more likely interact through an electronic link 183 directly with registration database 154. Matching software component 156 then sends messages out to sellers having matching conditions to those of one or more buyer conditions, as indicated by dashed communications links 184. These communications may be e-mail, text messages, or even regular mail. As used herein “regular mail is deemed to include courier services, such as Federal Express, DHL, and the like. In embodiment 400, for simplicity of drawing, data such as seller information, seller information on vehicles for sale, and seller conditions on those sales and vehicles, as well as buyer information, vehicles each buyer is interested in purchasing, and buyer conditions, all may reside in a single registration database 154, but those skilled in the art will recognize that separate databases, or other combinations of databases, may be used, and the present disclosure is not limited to any particular arrangement of databases.

As noted in FIG. 5A, buyers will post their offers through web-connected interfaces 158 to system server 150. System server filtering software 156 will then filter the buyer offers according to the seller conditions and then e-mail the buyer offer information to sellers using email software component 152, as indicated at 184. System server 150 will also electronically attach the buyer offer to the seller profile (stored in registration database 154) as an offer “e-mailed to the seller.” The seller then will log into the system via its web-connected device 170 and view the details of the “buyer offer” it has received via email. As illustrated in FIG. 5B, the seller will then accept the offer, reject the offer, provide an alternative, or other response, through the web interface of the system. The buyer then will be notified through e-mail of the sellers decision. Overall e-mail will only be used for notification purposes and the actual “actions” are performed using the MCAMP server 150 either through a web interface or a mobile interface.

FIG. 5C depicts buyer 160 sending “commit to buy” signal 204 and deposited a buyer's deposit via a second signal 206 for one seller 170. Buyer 160 is identified to seller 170 through an electronic communication link 208. At this stage the transaction is labeled “sale pending” by the system, but either buyer or seller may back out of the transaction. Financial software component 198 in system server interacts electronically with e-mail software component 152 to handle the financial maters between buyers, sellers, and system server 150, including retaining any deposit buyer 160 paid in order to initially bind a seller 170, but which did not lead to a consummated transaction, but the deposit is retained only if the system issue resolution process indicates that the fault was buyer's. Financial software component 198 would apply buyer's deposit toward the purchase price of the vehicle if a sale is consummated. A feedback software component 202 interacts through electronic communications with the e-mail software component. It will be understood that the financial software component 198 as well as the feedback software component 202 may be associated with and/or interact with various databases within system server 150, and outside of system server 150, as desired. For example, financial software component 198 may interact with ne or more banking websites and their respective databases, credit agencies, and the like.

From the foregoing detailed description of specific embodiments, it should be apparent that patentable methods and systems have been described. Although specific embodiments of the disclosure have been described herein in some detail, this has been done solely for the purposes of describing various features and aspects of the methods and systems, and is not intended to be limiting with respect to the scope of the methods and apparatus. It is contemplated that various substitutions, alterations, and/or modifications, including but not limited to those implementation variations which may have been suggested herein, may be made to the described embodiments without departing from the scope of the appended claims. For example, network-connectable devices other than those currently on the market may be developed, as well as software components and hardware components for use in systems and methods of this disclosure other than those specifically described above, and these may be employed with and are considered within this disclosure and the claims which follow.

What is claimed is:

1. A buyer-driven method of purchasing a motor vehicle, the method comprising:
one or more buyers composing a buyer-specific offer to purchase a motor vehicle and optionally motor vehicle-related services, each offer based on an individual buyer willing price that is based on
i) an individual buyer perceived value of the motor vehicle and related services, and
ii) one or more buyer-specific conditions imposed on purchasing a motor vehicle within the set of motor vehicles;
each buyer registering with, and communicating their respective buyer-specific offer for the motor vehicle to, a website hosted by a computer server, the website accessible by network-connected devices of the buyers via an information network comprising said server, and one or more website-registered sellers communicating their respective seller conditions to the website via the information network prior to any buyer financial information being communicated to the website by the buyers;
filtering, using software in or accessible to the computer server, one or more buyer-specific offers for the motor vehicle with respect to one or more registered seller conditions, the computer server electronically communicating only filtered buyer-specific offers to registered sellers;
the registered sellers communicating a response selected from the group consisting of accept, decline, or alternative response to the website;
if satisfied with one or more registered sellers' acceptance or alternative responses, each buyer selecting one registered seller the buyer wishes to purchase the motor vehicle from and anonymously communicating a “ready to purchase motor vehicle” signal and financial deposit information to the website for the selected registered seller, the website subsequently identifying the selected registered seller to the respective buyer and identifying the respective buyer to the selected registered seller;
the computer server then causing the website to indicate “pending sale” for the buyer and the selected registered seller;
only if the respective buyer remains committed to purchasing the vehicle from the selected registered seller and only if the registered seller commits to selling the vehicle to the buyer, then the selected registered seller and the respective buyer executing a purchase and sale contract for the motor vehicle using the website.

2. The method claim 1 wherein, if either the buyer or the seller decides to back out of the sale after the “pending sale” signal is posted on the website, the system server initiates an issue resolution procedure.

3. The method of claim 2 wherein the issue resolution procedure comprises the system server asking the buyer and seller to first discuss their differences for a specific “discussion period” period of time.

4. The method of claim 3 wherein, after the discussion period is concluded and if no resolution is made, the system initiates a dispute resolution procedure selected from the group consisting of mediation, arbitration, and combinations thereof, to determine which party is at fault for backing out of the “pending sale” and to penalize the party at fault.

5. The method of claim 1 wherein seller feedback is communicated anonymously to buyers.

6. The method of claim 5 further comprising the computer server anonymously ranking the seller feedback for each buyer-specific offer.

7. The method of claim 1 further comprising the selected sellers and the respective buyers each informing the website of the execution of their respective purchase and sale contracts.

8. The method of claim 1 further comprising the computer server retaining buyer deposits for those transactions not executed by buyers with selected sellers and for which the system determines the buyer is at fault.

9. The method of claim 1 comprising:
each buyer comparing their willing price to industry knowledge and adjusting their willing price to form a buyer-specific adjusted willing price; and
each buyer communicating their buyer-specific adjusted willing price to sellers via the information network.

10. The method of claim 9 wherein the motor vehicle is selected from the group consisting of automobiles, light-duty trucks, SUVs, and motorcycles, and the industry knowledge is selected from the group consisting of Kelly Blue Book value, NADA guide value, CarFax information, and combinations thereof.

11. The method of claim 9 wherein the industry knowledge is available online via the information network.

12. The method of claim 1 wherein the information network is the Internet.

13. The method of claim 1 wherein the information network is a private intranet.

14. The method of claim 9 wherein the industry information is available locally in the buyer's geographic area.

15. The method of claim 9 wherein the industry information is available globally.

16. The method of claim 1 comprising the server generating suggestions to the buyer about adjusting the buyer conditions and/or the willing price.

17. The method of claim 16 wherein the server generates the suggestions based on volume of seller acceptances, alternate solutions and decline comments.

18. The method of claim 1 further comprising one or more of the potential sellers providing one or more motor vehicle-related services selected from the group consisting of vehicle inspections, CARFAX reports, financial loans, vehicle insurance, dealer special offers and advertisements, vehicle maintenance services, extended warranties, and vehicle shipping/transportation.

19. The method of claim 1 wherein one of the potential sellers accepts one of the buyer-specific offers and the buyer and seller consummate a binding purchase and sale contract for a motor vehicle within the set of motor vehicles, and, optionally, services related to the motor vehicle.

20. The method of claim 19 wherein the purchase and sale contract is consummated through an online payment service.

21. The method of claim 20 wherein the purchase and sale contract is consummated through a wire transfer, or an electronic network for financial transactions such as ACH (Automated Clearing House), or using a credit card.

22. The method of claim 1 wherein if one or more of the sellers is not willing to sell to one or more of the buyers based on said buyer-specific offers, the one or more sellers communicating one or more actions selected from the group consisting of declining one or more of the buyer-specific offers and suggesting one or more alternatives to one or more buyer-specific offers.

23. The method of claim 1 further comprising one or more sellers registering with the computer server website and/or sponsor thereof and creating a seller profile identifying seller conditions and contact information for the seller, including one or more electronic mail addresses.

24. The method of claim 23 further comprising the computer server forwarding to one or more potential sellers one or more filtered buyer-specific offers by electronic mail to at least one of the electronic mail addresses identified on the seller profile using the information network.

25. The method of claim 24 further comprising a buyer-selected seller providing specific details of a motor vehicle or motor vehicle-related service that would be transacted by accepting the buyer-specific offer.

26. The method of claim 25 further comprising the selected seller uploading one or more images, videos or other descriptive material of the motor vehicle or motor vehicle-related service to be purchased to the computer server.

27. The method of claim 1 further comprising ranking sellers in a list of accepted buyer-specific offers and counteroffers according to buyer-specific criteria.

28. The method of claim 1 wherein buyer identities are not revealed to sellers, nor are seller identities revealed to buyers, before the “ready to purchase motor vehicle” signal is received by the system server.

29. A buyer-driven method of purchasing an automobile, the method comprising:
one or more buyers composing a buyer-specific offer to purchase an automobile and optionally automobile-related services, each offer based on an individual buyer willing price that is based on
i) an individual buyer perceived value of the automobile and related services, and
ii) one or more buyer-specific conditions imposed on purchasing the automobile within the set of automobiles;
each buyer registering with, and communicating their respective buyer-specific offer to, a website hosted by a computer server, the website accessible by network-connected devices of the buyers via an information network comprising said server, and one or more website-registered sellers communicating their respective seller conditions to the website via the information network prior to any buyer financial information being communicated to the website by the buyers;
filtering, using software in or accessible to the computer server, one or more buyer-specific offers for automobiles with respect to one or more registered seller conditions, the computer server electronically communicating only filtered buyer-specific offers to registered sellers;
the registered sellers communicating a response selected from the group consisting of accept, decline, or alternative response to the website;
if satisfied with one or more registered sellers' acceptance or alternative responses, each buyer selecting one registered seller the buyer wishes to purchase the automobile from and anonymously communicating a “ready to purchase automobile” signal and financial deposit information to the website for the selected registered seller, the website subsequently identifying the selected registered seller to the respective buyer and identifying the respective buyer to the selected registered seller;
the computer server then causing the website to indicate “pending sale” for the buyer and the selected registered seller;
only if the respective buyer remains committed to purchasing the automobile from the selected registered seller and only if the registered seller commits to selling the automobile to the buyer, then the selected registered seller and the respective buyer executing a purchase and sale contract for the automobile using the website.

30. A method of facilitating and capitalizing a buyer-driven method of purchasing a motor vehicle, the method of facilitating and capitalizing comprising:
setting up a website wherein a set of buyers and a set of sellers of motor vehicles register with the website via an information network, the information network comprising a computer server hosting the website accessible by network-connected devices of the buyers and sellers;
each individual buyer composing a buyer-specific offer to purchase a motor vehicle and optionally services, each offer based on an individual buyer willing price that is based on
i) an individual buyer perceived value of the motor vehicle and related services, and
ii) one or more buyer-specific conditions imposed on purchasing the motor vehicle;
one or more sellers composing one or more seller conditions on selling the motor vehicle;
the website facilitating buyers to communicate their respective buyer-specific offers to the website and sellers to communicate their respective seller conditions to the website via the information network prior to any buyer financial information being communicated to the website by the buyers;
filtering, using software in or accessible to the computer server, one or more buyer-specific offers with respect to one or more registered sellers and electronically communicating only filtered buyer-specific offers to registered sellers;
one or more sellers communicating to the website anonymous seller feedback selected from the group consisting of accepting, rejecting, and proposing one or more alternatives to one or more filtered buyer-specific offers;
the computer server anonymously associating the anonymous seller feedback with filtered buyer-specific offers and anonymously ranking on the website the seller feedback for each filtered buyer-specific offer;
one or more buyers evaluating the anonymous seller feedback and ranking, and, if satisfied with one or more sellers, each buyer selecting seller the buyer wishes to purchase the motor vehicle from and anonymously communicating a “ready to purchase motor vehicle” signal and financial deposit information to the website;
the website identifying the selected registered seller to the respective buyer and identifying the respective buyer to the selected registered seller, the selected registered seller and respective buyer;
the computer server then causing the website to indicate “pending sale” for the buyer and the selected registered seller;
only if the respective buyer remains committed to purchasing the vehicle from the selected registered seller and only if the registered seller commits to selling the vehicle to the buyer, then the selected registered seller and the respective buyer executing a purchase and sale contract using the website,
the selected seller and the respective buyer each informing the website of the execution of their purchase and sale contract; and
the computer server retaining the buyer deposit only for contracts that were not executed due to fault of the buyer.

31. The method of claim 30 wherein after evaluating anonymous seller feedback and ranking, but prior to communicating the “ready to purchase motor vehicle” signal and financial information to the website,
the buyer sending to the website one or more electronic messages addressed to the selected seller, the website then sending website-generated electronic messages to the selected seller.

32. The method of claim 31 wherein the one or more electronic messages includes the buyer requesting the seller inform the buyer of one or more motor vehicle-related services that the seller may provided, and optionally one or more quotes for those services.

33. A system comprising:
an information network comprising a computer server hosting a website accessible by network-connected devices of potential buyers and potential sellers of motor vehicles and related services, the computer server comprising features allowing buyers and sellers to register with the website, and allow buyers to upload buyer-specific purchase offers for motor vehicles and sellers to upload registered seller acceptances, alternate seller solutions and seller decline comments, without any obligation of buyers to consummate a purchase and sale contract,
the computer server further comprising, or having ability to electronically access remotely, software that allows the computer server to:
i) filter registered buyer-specific offers,
ii) communicate filtered buyer-specific offers to registered sellers using the information network,
iii) receive messages from buyers satisfied with one or more registered sellers' acceptance or alternative responses, the messages allowing the buyer to select a seller the buyer wishes to purchase the motor vehicle from and anonymously communicate a “ready to purchase motor vehicle” message and financial deposit information to the website, prior to the website identifying the selected seller to the respective buyer and the respective buyer to the selected seller;
iv) identify buyer-selected sellers and respective buyers using the information network,
v) execute respective purchase and sale contracts using the website, but only after the buyers and sellers identify themselves to each other using the website, and
vi) retain the buyer deposit for those instances where the buyer backs out of a “ready to purchase” status, but only if the buyer was at fault.

34. The system of claim 33 wherein the computer server comprises, or has ability to electronically access remotely one or more buyer-driven algorithms allowing buyers to access information available online in forming the buyer-specific purchase offers.

35. The system of claim 33 wherein the motor vehicle is selected from the group consisting of automobiles, light-duty trucks, sport utility vehicles, and motorcycles, and the information available online is selected from the group consisting of Kelly Blue Book value, NADA guide value, CarFax information, and combinations thereof.

36. The system of claim 33 wherein the computer server software is programmed to allow one or more buyers to rank seller acceptances and seller alternate solutions.

37. The system of claim 33 wherein the purchase order includes a willing price and buyer-specific conditions, the server comprising software programmed to generate suggestions to buyers about adjusting the buyer conditions and/or the willing price.

38. The system of claim 37 wherein the server software generates the suggestions based on information selected from the group consisting of volume of seller acceptances, alternate seller solutions and seller decline comments.

39. A computer-readable medium encoded with processing instructions for implementing a buyer-driven method of purchasing a motor vehicle, the method comprising:
one or more buyers composing a buyer-specific offer to purchase a motor vehicle and optionally motor vehicle-related services, each offer based on an individual buyer willing price that is based on
i) an individual buyer perceived value of the motor vehicle and related services, and
ii) one or more buyer-specific conditions imposed on purchasing a motor vehicle within the set of motor vehicles;
each buyer registering with, and communicating their respective buyer-specific offer for the motor vehicle to, a website hosted by a computer server, the website accessible by network-connected devices of the buyers via an information network comprising said server, and one or more website-registered sellers communicating their respective seller conditions to the website via the information network prior to any buyer financial information being communicated to the website by the buyers;
filtering, using software in or accessible to the computer server, one or more buyer-specific offers for the motor vehicle with respect to one or more registered seller conditions, the computer server electronically communicating only filtered buyer-specific offers to registered sellers;
the registered sellers communicating a response selected from the group consisting of accept, decline, or alternative response to the website;
if satisfied with one or more registered sellers' acceptance or alternative responses, each buyer selecting one registered seller the buyer wishes to purchase the motor vehicle from and anonymously communicating a “ready to purchase motor vehicle” signal and financial deposit information to the website for the selected registered seller, the website subsequently identifying the selected registered seller to the respective buyer and identifying the respective buyer to the selected registered seller;
the computer server then causing the website to indicate “pending sale” for the buyer and the selected registered seller;
only if the respective buyer remains committed to purchasing the vehicle from the selected registered seller and only if the registered seller commits to selling the vehicle to the buyer, then the selected registered seller and the respective buyer executing a purchase and sale contract for the motor vehicle using the website.

40. The computer-readable medium program of claim 39 wherein
each buyer compares their willing price to industry knowledge and adjusts their willing price to form a buyer-specific adjusted willing price; and
each buyer communicates their buyer-specific adjusted willing price to sellers via the information network.

41. The computer-readable medium program of claim 39 wherein the vehicle is selected from the group consisting of automobiles, light-duty trucks, SUVs, and motorcycles, and the industry knowledge is selected from the group consisting of Kelly Blue Book value, NADA guide value, CarFax information, and combinations thereof.

42. The computer-readable medium of claim 40 wherein the industry knowledge is available online via the information network.

43. The computer-readable medium of claim 39 comprising the server generating suggestions to the buyer about adjusting the buyer conditions and/or the willing price.

44. The computer-readable medium of claim 45 wherein the server generates the suggestions based on volume of seller acceptances, alternate solutions and decline comments.

45. The computer-readable medium of claim 39 further comprising one or more of the potential sellers providing one or more services selected from the group consisting of vehicle inspections, CARFAX reports, financial loans, vehicle insurance, dealer special offers and advertisements, vehicle maintenance services, extended warranties, and vehicle shipping/transportation.

46. The computer-readable medium of claim 39 wherein one of the potential sellers accepts the offer and the buyer and seller consummate a binding purchase and sale contract for a vehicle within the set of vehicles, and, optionally, services related to the vehicle.

47. The computer-readable medium of claim 46 wherein the purchase and sale contract is consummated through an online payment service.

48. The computer-readable medium of claim 46 wherein the purchase and sale contract is consummated through a wire transfer, or an electronic network for financial transactions such as ACH (Automated Clearing House), or using a credit card.

49. The computer-readable medium of claim 39 wherein if one or more of the sellers is not willing to sell to one or more of the buyers on said buyer-specific offers, the one or more sellers communicating one or more actions selected from the group consisting of declining one or more of the buyer-specific offers and suggesting one or more alternatives to one or more buyer-specific offers.

50. A computer-readable medium encoded with processing instructions for implementing a method of facilitating and capitalizing a buyer-driven method of purchasing a motor vehicle, the method of facilitating and capitalizing comprising:
setting up a website wherein a set of buyers and a set of sellers of motor vehicles register with the website via an information network, the information network comprising a computer server hosting the website accessible by network-connected devices of the buyers and sellers;
each individual buyer composing a buyer-specific offer to purchase a motor vehicle and optionally services, each offer based on an individual buyer willing price that is based on
i) an individual buyer perceived value of the motor vehicle and related services, and
ii) one or more buyer-specific conditions imposed on purchasing the motor vehicle;
one or more sellers composing one or more seller conditions on selling the motor vehicle;
the website facilitating buyers to communicate their respective buyer-specific offers to the website and sellers to communicate their respective seller conditions to the website via the information network prior to any buyer financial information being communicated to the website by the buyers;
filtering, using software in or accessible to the computer server, one or more buyer-specific offers with respect to one or more registered sellers and electronically communicating only filtered buyer-specific offers to registered sellers;
one or more sellers communicating to the website anonymous seller feedback selected from the group consisting of accepting, rejecting, and proposing one or more alternatives to one or more filtered buyer-specific offers;
the computer server anonymously associating the anonymous seller feedback with filtered buyer-specific offers and anonymously ranking on the website the seller feedback for each filtered buyer-specific offer;
one or more buyers evaluating the anonymous seller feedback and ranking, and, if satisfied with one or more sellers, each buyer selecting seller the buyer wishes to purchase the motor vehicle from and anonymously communicating a “ready to purchase motor vehicle” signal and financial deposit information to the website;
the website identifying the selected registered seller to the respective buyer and identifying the respective buyer to the selected registered seller, the selected registered seller and respective buyer;
the computer server then causing the website to indicate “pending sale” for the buyer and the selected registered seller;
only if the respective buyer remains committed to purchasing the vehicle from the selected registered seller and only if the registered seller commits to selling the vehicle to the buyer, then the selected registered seller and the respective buyer executing a purchase and sale contract using the website,
the selected seller and the respective buyer each informing the website of the execution of their purchase and sale contract; and
the computer server retaining the buyer deposit only for contracts that were not executed due to fault of the buyer.
